(19) United States
(12) Patent Application Publication
(10) Pub. No.: US 2004/0102971 A1
(43) Pub. Date: May 27, 2004

(54) Method and system for context-sensitive recognition of human input

(75) Inventors: Randolph B. Lipscher, Austin, TX (US); Michael D. Dahlin, Austin, TX (US)

Correspondence Address: TOLER & LARSON & ABEL L.L.P., 5000 PLAZA ON THE LAKE STE 265, AUSTIN, TX, 78746, US

(73) Assignee: RECARE, Inc.

(21) Appl. No.: 10/638,961

(22) Filed: Aug. 11, 2003

Related U.S. Application Data
(60) Provisional application No. 60/402,498, filed on Aug. 9, 2002.

(51) Int. Cl. G10L 15/12

(52) U.S. Cl. 704/236

(57) ABSTRACT

In a particular embodiment, the disclosure is directed to a method of recognizing input that includes receiving input data; receiving context data associated with the input data, the context data associated with an interpretation mapping; and generating symbolic data from the input data using the interpretation mapping. In another particular embodiment, the disclosure is directed to an input recognition system that includes a context module, an input capture module, and a recognition module. The context module is configured to receive context input and provide context data. The input capture module is configured to receive input data and is configured to provide digitized input data. The recognition module is coupled to the context module and is coupled to the input capture module. The recognition module is configured to receive the digitized input data and to interpret the digitized input data utilizing an interpretation mapping associated with the context data.

### CROSS-REFERENCE TO RELATED APPLICATION(S)

The present application claims priority from U.S. provisional patent application No. 60/402,498, filed Aug. 8, 2002, entitled “Method and Apparatus for context-sensitive recognition of human input,” naming inventors Randolph B. Lipscher and Michael D. Dahlin, which application is incorporated by reference herein in its entirety.

### FIELD OF THE INVENTION

This invention generally relates to human input recognition. More specifically, this invention relates to voice and handwriting recognition using context-sensitive recognition and human-assisted feedback correction.

### BACKGROUND

Various human inputs into computation systems require interpretation by computer. Examples include Voice and handwriting recognition. Typical interpretation systems require intense computation or rely on single broad dictionaries to interpret the input. As such these systems are slow and unreliable. The lack of speed often leads to the systems falling behind, leaving gaps in the output from the interpretation.

Further, these systems are prone to error. The error is in part caused by speed of the system relative to real-time human input speeds. In addition, error is caused by misinterpretation of the input.

### SUMMARY

In a particular embodiment, the disclosure is directed to a method of recognizing input. The method includes receiving input data; receiving context data associated with the input data, the context data associated with an interpretation mapping; and generating symbolic data from the input data using the interpretation mapping.

In another particular embodiment, the disclosure is directed to an input recognition system. The input recognition system includes a context module, an input capture module, and a recognition module. The context module is configured to receive context input and provide context data. The input capture module is configured to receive input data and is configured to provide digitized input data. The recognition module is coupled to the context module and is coupled to the input capture module. The recognition module is configured to receive the digitized input data. The recognition module is configured to interpret the digitized input data utilizing an interpretation mapping associated with the context data.

In another particular embodiment, the disclosure is directed to a medical system. The medical system includes at least one input capture module, a context module, a plurality of interpretation mappings, and a recognition module. The at least one input capture module is configured to capture input data and provide digitized input data. The context module is configured to receive medical workflow data and provide context data. The context data is associated with at least one interpretation mapping of the plurality of interpretation mappings. The recognition module is configured to generate symbolic data from the digitized input data utilizing the at least one mapping associated with the context data.

### BRIEF DESCRIPTION OF THE DRAWINGS

FIG. 1 illustrates an embodiment of a natural input recognition system.

FIG. 2 depicts an exemplary method of input recognition.

FIG. 3 illustrates an exemplary embodiment of a natural input recognition system.

FIG. 4 depicts an exemplary method for input recognition.

FIG. 5 illustrates an exemplary embodiment of a natural input recognition system.

FIG. 6 depicts an exemplary method for input recognition.

FIG. 7 illustrates an exemplary embodiment of a natural input recognition system.

FIG. 8 depicts an exemplary method for input recognition training.

FIG. 9 illustrates an exemplary embodiment of a natural input recognition system.

FIG. 10 depicts an exemplary method for input recognition training.

FIG. 11 illustrates an exemplary embodiment of a natural input recognition system.

FIG. 12 depicts an exemplary method for input recognition training.

FIG. 13 illustrates an exemplary embodiment of a natural input recognition system.

FIG. 14 depicts an exemplary method for input recognition.

FIG. 15 illustrates an exemplary embodiment of an input capture module.

FIG. 16 illustrates an exemplary embodiment of a feedback module.

FIG. 17 illustrates an exemplary embodiment of a recognizer module.

FIGS. 18, 19, 20, and 21 illustrates an exemplary embodiment of a natural input cognition system.

FIG. 22 depicts an exemplary embodiment of a context module.

FIG. 23 depicts an exemplary application of context-sensitive recognition.

The use of the same reference symbols in different drawings indicates similar or identical items.

### DESCRIPTION OF THE DRAWINGS

This disclosure describes a natural human input recognition system that is applicable to recognition systems such as voice-to-text translation or handwriting-to-text translation.

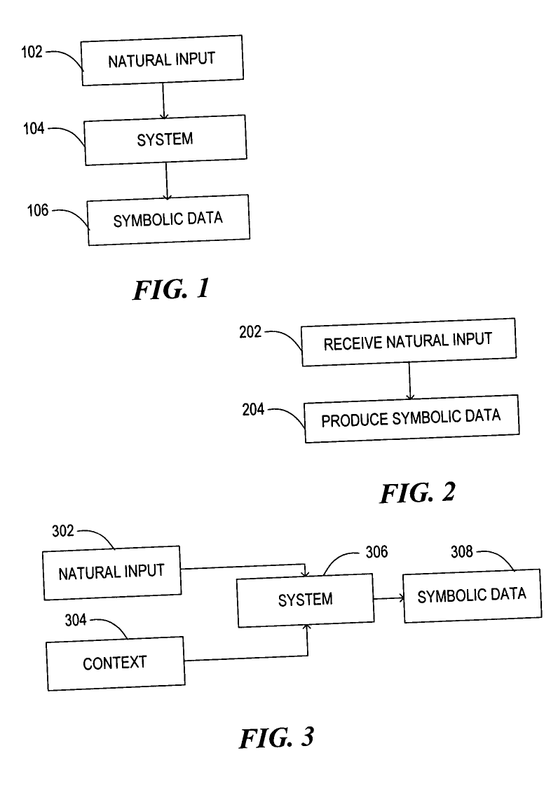

FIG. 1 illustrates an embodiment of a natural input recognition system. Natural input 102 is directed to a recognition system 104. The recognition system 104 generates symbolic data from the natural input 102.

A human input recognition system takes natural input as input and produces symbolic data output. Natural input may be any form of input produced by a human or communication form suitable for human-to-human communication. Examples may include voice, speech, gestures, handwriting, facial expression, or a drawing/sketch/schematic. Symbolic data are collections of values that can represent data in a computer. Examples may include words, phrases, letters, numbers, unicode symbols, values for database record, computer program variable values, and computer program variable addresses. Symbolic data output may be output by the system, stored by the system, displayed by the system, or transmitted to another system. However, the symbolic data and natural input may take various forms. Further, various conversions may be envisaged.

FIG. 2 is a flow chart describing the actions taken by an embodiment of a natural input recognition system. A user provides natural input to the system as shown in step 202, and the system produces symbolic data corresponding to that natural input, as shown in step 204.

FIG. 3 illustrates an embodiment of the natural input recognition system that also takes context as input. In one embodiment, the system 306 takes natural input 302 and context input 304 and produces symbolic data 308. The system 306 adapts the interpretation of the natural input 302 based on the context input 304. The system 306 may utilized a specialized mapping based on the context input 304. Alternately, the system 306 may select a set of interpretation mappings based on the context input 304.

Context is information describing the situation in which the input is provided. Examples of context include the task being performed such as administering a medical physical exam, writing a medical prescription, administering a medical physical exam of the hand, administering a medical physical exam for someone who has complained of back pain, ordering a blood test for a medical patient, tuning an automobile engine, repairing an automobile engine for a 1997 Ford Mustang with a V-8 engine, repairing an automobile engine for a 1997 Ford Mustang with a V-8 engine that makes a clicking sound, taking class notes about calculus, taking class notes about chapter 5 of the Calculus textbook Calculus with Analytic Geometry Second Edition by Howard Anton, entering sales data, entering sales data about auto parts, and entering sales data about manual transmission auto parts for Ford vehicles, among others.

The context may include a single data context such as writing a prescription. Alternately, the context may include a set of hierarchical data. For example, a physical exam of the hand may include physical exam context information and hand context information.

Another example of context information is the type of subject being examined. For example, in a medical application a patient's demographic information—such as age, gender, race, income, and location of residence—could act as context information. For example, in an auto repair application, factors such as a car's make, model, trim level, and year of manufacture could act as context information. For example, in a sales application, factors such as customer's type of business or number of employees could act as context information.

A further example of context information is stored information about the subject of an examination or procedure. For example, in a medical application, information stored about a patient being medically examined such as the patient's age, gender, name, past medical history findings, current and past medications, recent diagnoses, chief complaint, history of present illness findings, and so on could serve as context information.

For example, in an auto repair application, information such as past repairs, recently diagnosed problems, and so on could act as context information. For example, in a sales application, information such as item numbers in past sales to a customer, descriptions of items in past sales to a customer, recent correspondence with a customer, and so on could act as context information.

Another example of context information is the current or recent physical location of the user. For example, in a real estate application, a real estate agent dictating to a laptop that includes a GPS could use the location of the agent as context. For example, in a medical application, the room that a health care provider is in or was last in could be regarded as context information.

Context information may also include the subroutine of a computer-aided workflow. For example, if a workflow has several steps that take natural input, then the step currently in progress could act as context in the recognition system. For example, in a voice-driven telephone customer service application, one example context could be the “confirm customer address” task while another example context could be the “receive ordered item number” task. For example, in a graphical computer input interface application, the window or frame that the user last touched with a mouse click or a stylus tap could represent the current context.

In a multi-component context embodiment, one or more types or items of information may be combined to represent a multi-component context. For example, in one embodiment of a medical point-of-care electronic medical record application, several factors such as the current patient (e.g., Mr. Jones, age 55, male), the chief complaint (e.g., chest pain), the diagnosis entered during this encounter (e.g., heartburn), and the current task (e.g., write prescription) could together represent the context.

Different contexts can be active at different times for the same user. A context change might not directly update mappings between a particular natural input and the corresponding symbolic data recognized by the system. Instead, it may change a collection of one or more mappings. For example, selecting the context “fruit” rather than the context “general” might not directly alter the mappings from natural inputs to either the words “fruit” or “general” while it might alter the mappings from the space natural inputs to other words, for example increasing the probability that given inputs map to the words “orange, ” “lime,” and “grape” while reducing the probability that the given inputs map to the words “porridge,” “time,” and “great.”

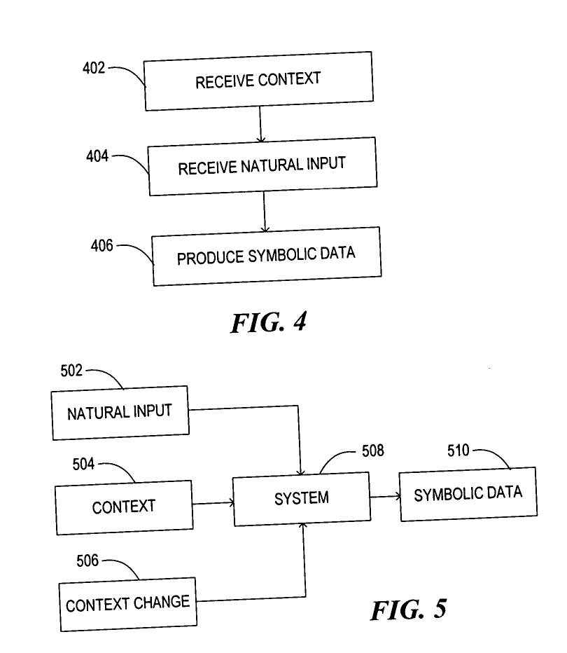

FIG. 4 is a flow chart describing the actions taken by an embodiment of a natural input recognition system that accepts context input. In this embodiment, the system receives context input, as shown in step 402. The user provides natural input to the system, as shown in step 404, and then, the system produces symbolic data corresponding to the natural input in the specified context, as shown in step 406. The user may continue to provide additional natural input in this context, and the system will produce additional symbolic data by interpreting the natural input in the current context. Alternatively, a new context may become active, at which point future natural input will be interpreted in the new context. Notice that the same natural input may produce different symbolic data outputs if that natural input is provided different contexts. For example, in a handwriting translation for electronic medical record embodiment, the same natural input might be interpreted as “Mrs. Johnson” when the context is that the current patient is a female named Claire Johnson and as “Mrs. Johnstone” when the context is that current patient is a female named Amy Johnstone.

FIG. 5 illustrates an embodiment that also takes context change as input. In this embodiment, the system 508 takes natural input 502, context 504, and context change 506 as input and produces symbolic data 510. Context change is any alteration of the relevant context data that affects the mapping of natural input to symbolic data. Two example types of context change are navigation and context update.

Navigation inputs are inputs that change what set of information is relevant context. For example, navigation inputs may include selecting a computer menu item, selecting a graphical window, selecting a graphical window frame, selecting a task, completing a task, selecting a patient, selecting a subject, or entering information, findings, or orders about a patient or subject. In one embodiment, navigation inputs are supplied as digital or discrete input, such as selecting an item by a mouse click, stylus tap on a touch screen, or finger tap on a touch screen. In another embodiment, navigation inputs are supplied as natural input, such as saying the words “next screen”, saying the name of a task, providing natural input that completes a task, making a gesture in the air with a hand, shaking or nodding one's head, or shaking the input device in the air to activate a motion sensor.

Context update input is any input that adds, modifies, or deletes elements from the current context. For example, in a medical context, the “History of Present Illness” context might include information relating to findings about the current patient that have been entered into the system. As new findings are entered, an embodiment of the system updates the context to include these new findings and information relating to these findings in the context.

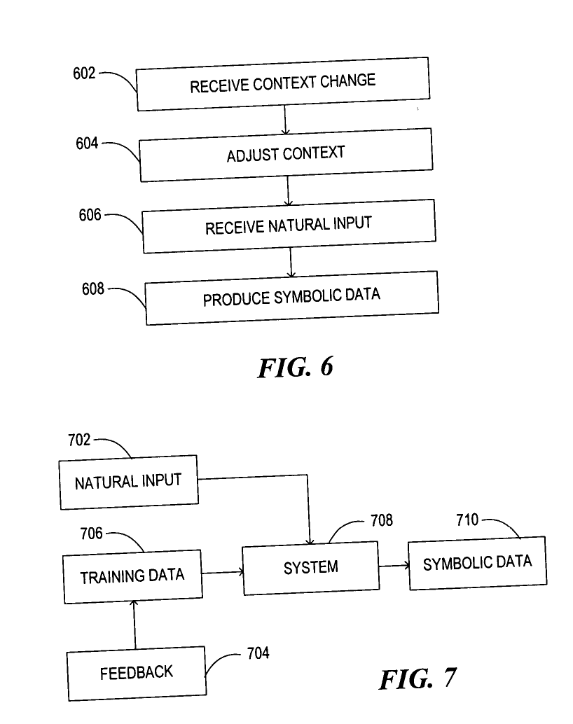

FIG. 6 is a flow chart describing the actions taken by an embodiment of a natural input recognition system that accepts context change input. As shown in step 602, the system receives context change input. The system then changes, selects, or updates a context based on this navigation input, as shown at step 604. The system then receives natural input, as shown at step 606, and using the context and the natural input, the system produces symbolic data corresponding to the natural input interpreted in the current context, as shown at step 608. The user may continue to provide natural input by repeating step 606, or the user may provide navigation input by repeating step 602.

FIG. 7 illustrates an embodiment in which the system uses feedback from users to adjust the algorithms or training data used internally by its recognition system. The system 708 produces symbolic data 710 from the natural input 702 utilizing training data 706. The training data is derived at least in part from feedback 704.

Training data is data that encodes patterns of natural input to symbolic data mappings for a user or group of users. For example, statistical information about the words or phrases that a user commonly users is one type of training data. For example, statistical information about a user's speech patterns and the resulting symbolic data (words) is one type of training data. Methods for using training data to enhance natural input recognition include calculating conditional probabilities, configuring neural networks, decision trees, and the like.

It should be noted that context (described above) differs from training data. For one thing, context can represent activities, subjects, topics of information, while training data represents mappings from natural input to symbolic output independent of context. In one embodiment, training data is associated with a user or group of users while context is associated with a task or subject. A set of training data may be selected from a library of training data based on the context data.

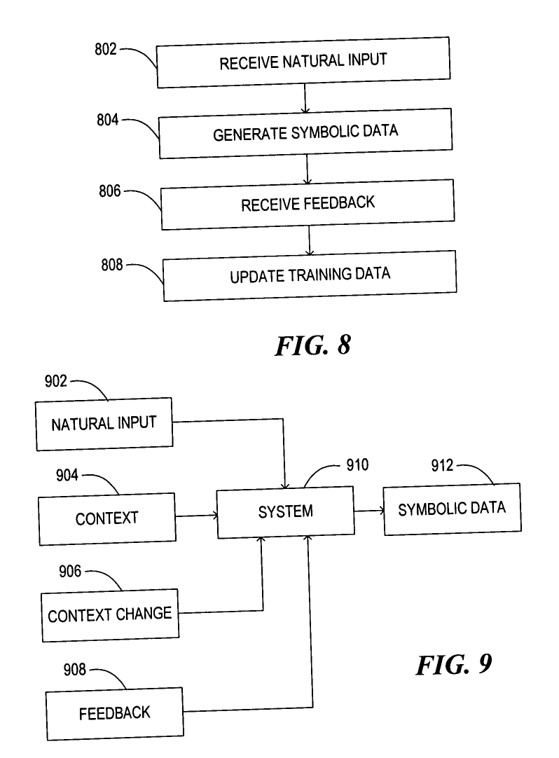

FIG. 8 is a flow chart describing the actions taken by an embodiment of a natural input recognition system that utilizes feedback for training. In this embodiment, the system receives natural input, as shown in step 802, and generates symbolic data, as shown in step 804. The system may continue to receive natural input and generate data, or at any point, the system may receive feedback, as shown at step 806, which it uses to update its training data to improve future recognition. For example, in one voice recognition embodiment, after a user says “apple,” the recognition system might produce the symbolic data “attle.” The user would recognize the error on the screen, select the word “attle” on the screen, and activate a correction subroutine by typing the word “apple.” The system would then update its data, as shown in step 808, to increase the probability that when the user makes sounds similar to the sounds she just made, the system will be more likely to recognize those sounds as the word “apple” and less likely to map those sounds to the word “attle.”

FIG. 9 illustrates an embodiment that combines feedback and context. In this embodiment, feedback 908 is used to update mappings from particular sets of natural inputs 902 to sets of symbolic data 912, and context 904 is used to adjust or select collections of such mappings. For example, the feedback subsystem would update the probability of recognizing a collection of sounds as the word “apple” rather than “addle” when the user corrects a mistranslation of a spoken word. For example, the context subsystem would update the probability of recognizing a collection of sounds as the word “apple” when the user selects the “shopping for fruit” context as opposed to the “general context” or the “shopping for electronic equipment” context.

In one embodiment, feedback updates natural input to symbolic output mappings for the current context. In one embodiment, feedback updates global mappings that are relevant to all contexts. In one embodiment, feedback updates both per-context mappings and global mappings, with differing weights on the updates.

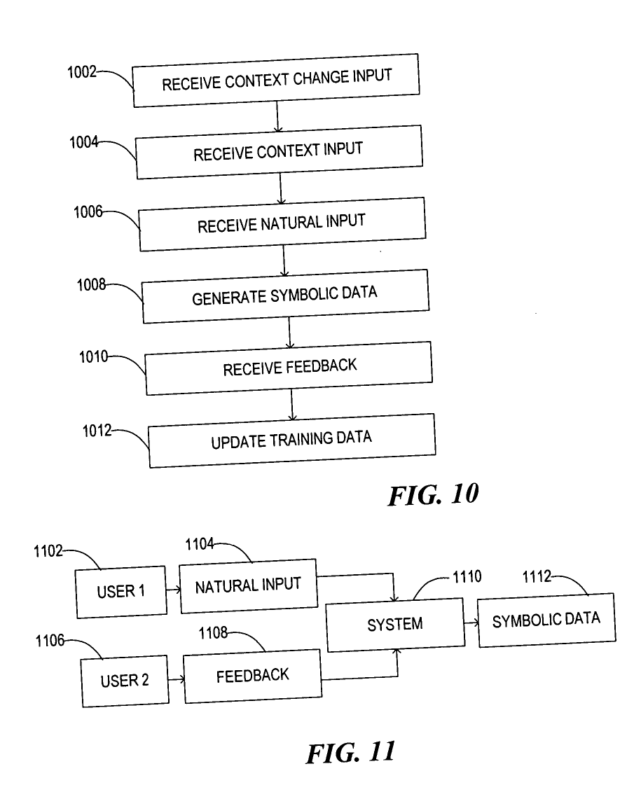

FIG. 10 is a flow chart describing the actions taken by an embodiment of a natural input recognition system that utilizes feedback and context. In this embodiment, the system receives context change input and context input, as shown in steps 1002 and 1004. The system receives natural input, as shown in step 1006, and generates symbolic data, as shown in step 1008. It may continue to receive natural input or context input and repeat these actions. Or it may receive feedback, as shown in step 1010, which it uses to update its training data, as shown in step 1012.

FIG. 11 illustrates an embodiment in which two users 1102 and 1106 interact with the system. The first user 1102 provides natural input 1104 and the system 1110 generates symbolic data 1112. The system then transmits the symbolic data 1112 to the second user 1106. The second user 1006 provides feedback 1108 (e.g., corrections to the symbolic data), which the system 1110 then uses to improve its recognition mappings.

In a per-user training data embodiment, the updates provided by the second user 1106 update the training data that the system 1110 uses for recognizing natural input by the first user.

In one embodiment, both the symbolic data 1112 and the natural input 1104 are sent by the system to the second user 1106. The second user 1106 then has access both to the original natural input 1104 and the generated symbolic output 1112 when providing feedback 1108.

For example, in a speech recognition dictation embodiment: user A speaks, system displays proposed symbolic data to user B (while, optionally, playing the original speech through speakers or headphone to user B), user B selects/corrects symbolic data; corrected words go back to recognition system; recognitions system marks the selected words as “more1 likely” and/or adds any new words to its internal symbolic dictionary.

In one embodiment the system stores the natural input and the symbolic data before sending it to the second user. The second user thus may provide feedback “off line”—at a time considerably after the first user provides the natural input. In one embodiment, the system stores the natural input and does not immediately generate symbolic data. The symbolic data is generated at a later time. The second user then provides feedback.

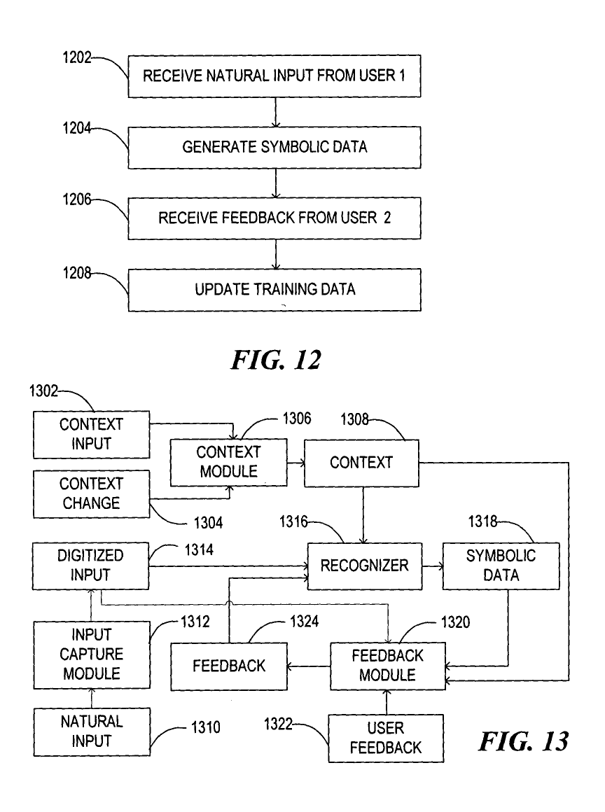

FIG. 12 is a flow chart describing the actions taken by an embodiment of a natural input recognition system in which two users interact with the system. The first user provides natural input, as shown in step 1202, and the system generates symbolic data, as shown in step 1204. The system then transmits the symbolic data to the second user. The second user provides feedback, as shown in step 1206 (e.g., corrections to the symbolic data), which the system then uses to update its training data, as shown in step 1208.

FIG. 13 illustrates the main modules of an embodiment of a recognition system. In this embodiment, a context module 1306 generates the appropriate context 1308 and feeds it to the recognizer module 1316. The context module 1306 accepts context input information 1302 (i.e., the context to use is provided from an external source) or context change information 1304 (i.e., the context module maintains context state that is updated) or both. As noted above, in one embodiment content change information 1304 can be navigation information or content update information or both. The context input 1302 and context change information 1304 can be supplied from various types of sources such as from external sources (such as other computers, other programs, or computer networks), from digital user input (such as selecting a menu item, making a window active, checking a checkbox), or from symbolic output from the recognizer (such as words to store or navigation commands).

In this embodiment, the input capture module 1312 captures human natural input 1310 (such as voice, gestures, handwriting, sketches) and produces a digital natural data encoding 1314 (such as a stream of bits on a wire, an array of bytes on a network, or typed data in a computer program).

The recognizer module 1316 produces symbolic data 1318 based on digital natural data 1314, context data 1308, and feedback data 1324.

The feedback module 1320 receives digital natural input 1314, symbolic data 1318, and user feedback 1322 and produces feedback 1324. In one embodiment, this feedback 1324 represents the intended symbolic data that should have been produced for the specified digital natural input 1314.

These modules may run together on a single system, or separately on various systems, or in various combinations. However, various system configurations may be envisaged. For example all of the system elements may be run on a computer, collection of computers, and networks, among others, with various storage, memory, and processors, among others.

While the diagram illustrates direct flows of data between modules, that these data flows may be accomplished via a number of means such as computer DRAM memory, computer non-volatile disk storage, computer networks, procedure calls, remote procedure calls, asynchronous messaging such as IBM's MQS system, and combinations of means. Not all data flows need to use the same communication means. It will further be apparent that in some embodiments, one or more of these communication flows may be asynchronous, in which case considerable time may elapse between the production of data by one module and its consumption by another. For example, in one embodiment digital natural input and context data may be stored on disk for several hours before being fed to the recognizer system. Furthermore, in some embodiments, different users can provide different subsets of the inputs. For example, in one embodiment, one user may provide the natural input while another provides feedback.

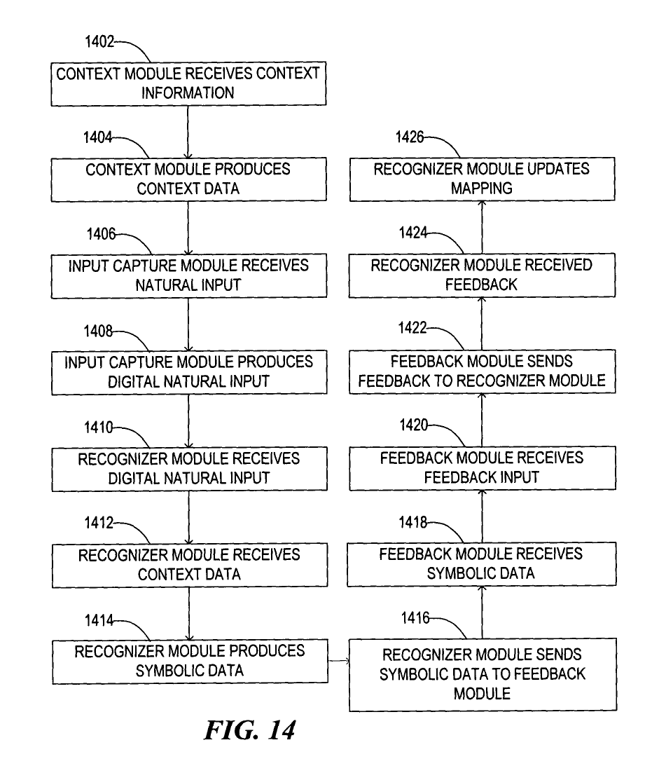

FIG. 14 is a flow chart describing the actions taken by an embodiment of a natural input recognition system. In this embodiment, as shown in step 1402, the context module receives context input or context change data, as shown in step 1404, generates the relevant context, and, as shown in step 1406, sends it to the recognizer module. If the next input is context input or context change data, the system returns to step 1402.

Otherwise, if the next input is natural input, as shown in step 1406, the input capture module receives natural input, as shown in step 1408, digitizes it, and as shown in step 1410, sends it to the recognizer module. As shown in step 1414 the recognizer module then produces symbolic data. As shown in step 1416, the recognition module sends the symbolic data to the feedback module, which receives it as shown in step 1418. Then, if the next input is context input or context change data, the system returns to step 1402.

Otherwise, if the next input is natural input, the system returns to step 1406. Otherwise, if the next input is user feedback, the system proceeds as shown in step 1420, in which the feedback module receives feedback input. Then, as shown in step 1422, the feedback module sends feedback to the recognizer. As shown in step 1424, the recognizer receives the feedback. Then, as shown in step 1426, the recognizer updates the mapping from digital natural inputs to symbolic data according to this feedback. Depending on the next input, the system then proceeds to step 1 or step 4.

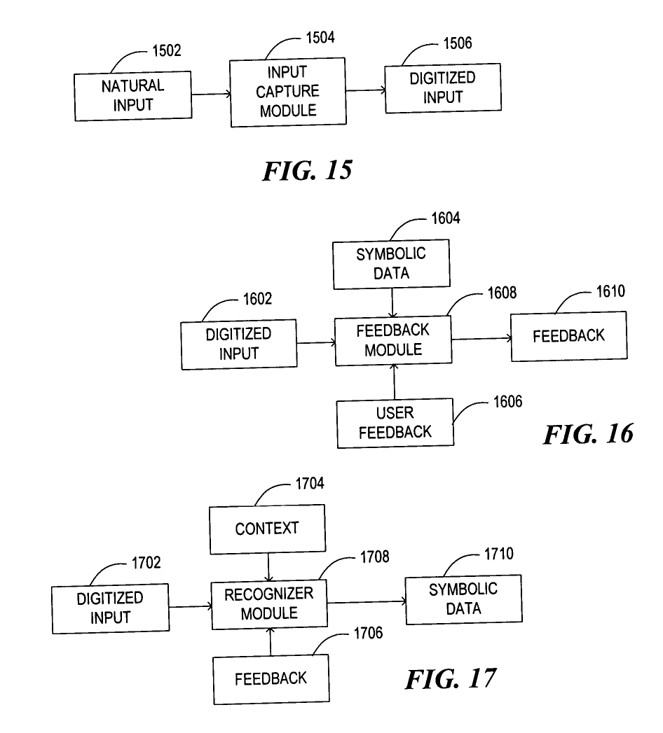

FIG. 15 illustrates an embodiment of an input capture module. In this embodiment, the input capture module 1504 captures human natural input 1502 (such as voice, gestures, handwriting, sketches) and produces a digital natural data encoding 1506 (such as a stream of bits on a wire, an array of bytes on a network, or typed data in a computer program). A large number of such systems will be familiar to designers familiar with the art. Examples include analog microphones with analog-to-digital conversion boards such as are found with many commodity SoundBlaster (™) compatible audio cards, microphones with USB digital connections, touch screens and styluses such as available on the Palm, Inc. Palm Vx(™) computer and on the tablet form-factor Hitachi HPW-600ET computer, and such as a digital video camera such as the Oregon Scientific Inc Y-Cam, which captures video and produces digital data with a USB interface.

In the exemplary embodiment shown in FIG. 16, the feedback module 1608 receives digital natural input 1602, symbolic data 1604, and user feedback 1606 and produces feedback 1610. In one embodiment, this feedback 1610 represents the intended symbolic data that should have been produced for the specified digital natural input. In one embodiment, the feedback 1610 is simply encoded as the symbolic output that should have been produced by the recognizer for the last digital natural input received by the recognizer. In a second embodiment, each set of symbolic data sent by the recognizer to the feedback module 1608 includes a unique identifier, and the feedback 1610 sent from the feedback module 1608 to the recognizer is encoded as the unique identifier or identifiers for the symbol or symbols to be corrected followed by the symbolic data that should be substituted for the symbolic data 1604 originally produced. Such an embodiment would be appropriate for allowing the feedback module to correct a range of characters in an ASCII or unicode text buffer.

In one embodiment, the feedback module 1608 does not rely on digital natural input, and thus, input may be omitted from the module. One example of such an embodiment is a digital speech to text system in which the feedback module 1608 displays the generated symbols (i.e., text) and allows correction of this text using keyboard or mouse driven text-editing commands. In another embodiment, the feedback module 1608 emits both the natural input and the symbolic output to facilitate feedback. For example, in a 2-person dictation embodiment, a first person dictates text verbally, and a second person receives both the system generated symbolic text and a digital recording of the original dictation sounds. The second person both listens to the sounds and looks at the produced text in order to identify errors and provide feedback.

FIG. 17 illustrates the inputs and outputs of an embodiment of the recognizer subsystem. The recognizer subsystem 1708 takes as input digital natural input 1702 and produces symbolic data 1710 as output. In one embodiment, it also takes context 1704 as input. Different contexts may cause the same digital natural input to be interpreted in different ways—e.g., to produce different symbolic data outputs. In one embodiment, it also takes feedback 1706 as input. Feedback 1706 specifies the correct translation from a specific digital natural input set to a specific symbolic data set.

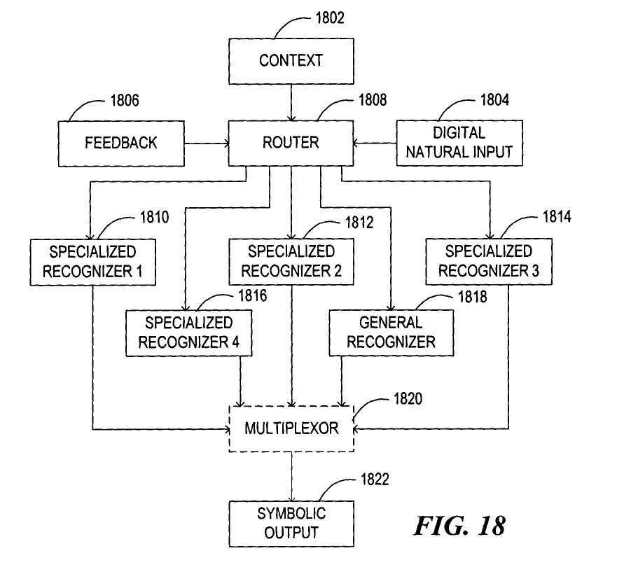

FIG. 18 illustrates an embodiment in which context is used to select from among the outputs of multiple recognizer algorithms. In this embodiment, digital natural input 1804 is sent to several different specialized recognizers (1810, 1812, 1814, and 1816) or a general recognizer 1818. The context 1802 may be used in conjunction with a router to route the digital natural input 1804 to the recognizers (1810, 1812, 1814, 1816, and 1818). Each of the specialized recognizers (1810, 1812, 1814, and 1816) is designed and tuned to work well for a particular subset of contexts. In one embodiment, each specialized recognizer (1810, 1812, 1814, and 1816) is a complete natural-input-to-symbolic data system. Each copy of the system has been tuned to work well in a particular context—for example, by instantiating it with a different dictionary or language model of words and phrases and their probabilities of use.

Alternately, the context input may be fed to a multiplexor (MUX) 1820, which selects the symbolic data output from one of the recognizers (1810, 1812, 1814, 1816, and 1818) according to the context 1802.

In addition, if feedback 1806 is supplied that indicates that natural input X should correspond to symbolic data Y, the router ensures that the feedback 1808 is routed to only the specialized recognizer that corresponds to the current context.

For example, in one medical data input embodiment, four contexts are numbered 0 (“general medical”), 1 (“prescription pad”), 2 (“history of present illness”), and 3 (“enter diagnosis”), and the context supplied corresponds to the current phase of the medical encounter or task being performed by the physician using the system. In one embodiment, each specialized recognizer produces its best selection of symbolic data corresponding to each natural input, but only the set of symbolic data relevant to the current context is emitted by the system. In another embodiment, the digital natural input is directed to a selected specialized recognizer, resulting the symbolic output 1822.

In one embodiment, rather than always selecting the output from the relevant context as in the multiplexor embodiment illustrated above, the system weights different outputs more heavily depending on the context. For example, in an embodiment, each specialized recognizer produces a symbolic output and a probability estimate that the specified symbolic output is a correct translation of the digital natural input. In this embodiment, the context selects a weighting of the specialized recognitions. For example, in a variation of the medical input embodiment described above, when context 3 (“enter diagnosis”) is active, the weights to different predictions are set to (0.5, 0.0, 1.0, 0.0), meaning that the “general medicine” prediction will be selected if its specialized predictor's confidence in its prediction is twice as high as the “enter diagnosis” prediction (and the predictions of the “prescription pad” and “history of present illness” specialized predictors are ignored.)

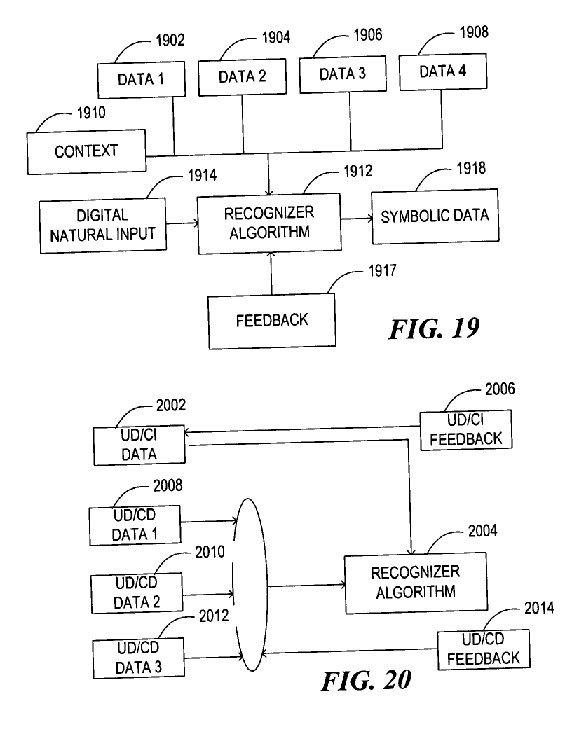

FIG. 19 illustrates an embodiment of the recognizer in which different contexts use the same basic recognizer subsystem but make different data sets active. In one embodiment, instead of each specialized recognizer being a complete natural-input-to-symbolic-output subsystem, all conceptual specialized recognizers are in fact implemented by the same recognizer algorithm subsystem. This subsystem is parameterized in order to work well in different situations. As illustrated in FIG. 19, the context 1910 is used to select which parameters and state are available to the recognition subsystem by selecting data1 (1902), data2 (1904), data3 (1906), or data4 (1908) to be accessed by the recognizer algorithm 1912. Each of the different data sets (1902, 1904, 1906, and 1908) comprises one or more collections of input to the recognizer algorithm 1912 such as a dictionary of words, a set of (word, probability) pairs, a set of phrases, a set of (phrase, probability) pairs, or a set of (natural input, phrase, probability) tuples. Also in this embodiment, feedback 1917 that updates the mapping from natural input to symbolic data is used to update the active data set. The recognizer algorithm 1912 converts the digital natural input 1914 to symbolic data 1918 using the data set (1902, 1904, 1906, or 1908) associated with the context 1910.

FIG. 20 illustrates an embodiment in which recognizer data is divided into user-dependent, context-dependent data and user-dependent, context-independent data. In another embodiment, the recognizer system breaks recognizer data into two parts. The first part contains data pertaining to user-dependent, context-independent data (UD/CI) 2002. The second part contains data pertaining to user-dependent, context-dependent data (UD/CD) (2008, 2010, and 2012.) For example, in one voice to text embodiment, user-dependent, context-independent data (2002) comprises data describing a user's pronunciation of different words while user-dependent, context-dependent data comprises data about the frequency with which different words and phrases are uttered in a context. In this embodiment, feedback is also split to update the corresponding subsets of data (2006 and 2014).

In another embodiment, the recognizer data is also split into two parts with the same functional purposes. The first set is user-dependent, context-independent data 2002 but the second set is user-independent, context-dependent data (2008, 2010, and 2012) (i.e., data that corresponds to the context but that is collected across a collection of different users.)

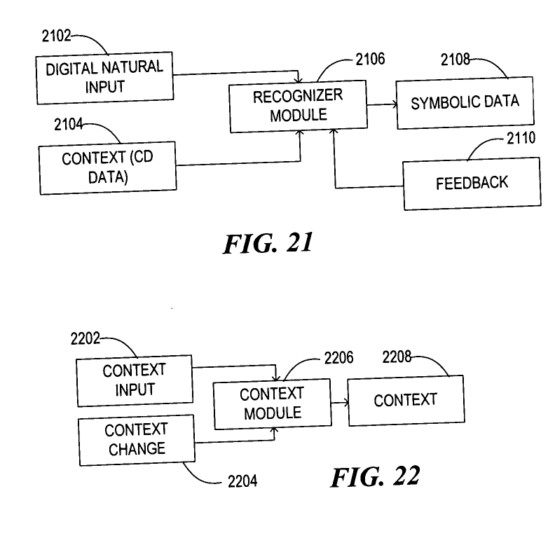

FIG. 21 illustrates an embodiment in which context-dependent data is supplied to the recognizer subsystem. The recognizer module 2106 utilizes that digital natural input 2102 in conjunction with the context dependent data 2104 to produce the symbolic data 2108. Rather than storing context dependent data in the recognizer and selecting a set of context-dependent data using the context, the context-dependent data is provided directly as the context. For example, in a medical handwriting recognition embodiment, the enclosing system provides a list of words relating to the current patient (e.g., the patient's name, a list of the patient's current medications, a list of past diagnoses that have been made about the patient, and a list of active problems for the patient) as well as a list of words relating to the current task. For example, one task is “history of present illness” (where, in this embodiment, words and phrases relating to the selected chief complaint are supplied; e.g., when the chief complaint is chest pain and the current task is history of present illness, words and phrases such as “chest”, “heart”, “smoking”, “difficulty breathing”, “fatigue”, are supplied). In this embodiment, other tasks are “write prescription”, “enter diagnosis”, “order laboratory test”, “edit past medical, family and social history”, “enter justification for MRI test”, “comment on range of motion of right elbow”, and so on. In one embodiment using this technique, the recognizer combines context-dependent data with a context-independent “baseline” set of data.

In a further embodiment, feedback 2110 applies to context independent training (e.g., updating models of the user's speech patterns) but feedback is used by the recognizer to update context-dependent data.

FIG. 22 illustrates the basic input/output flows of one embodiment of the context module. The context module 2206 supplies context 2208 to the recognizer module. The input 2202 to the context module is data that pertains to the situation in which the system is being used. In one embodiment, the context module 2206 maintains state regarding the current context, and context change inputs 2204 alter that state. In another embodiment, the context module 2206 is stateless, and information encoding the current context is provided as input. In a third embodiment, the context module 2206 maintains state regarding the current context, and this state is updated in two ways: incrementally (via context change inputs 2204) and en mass (via updates that encode the new context).

In one embodiment, the context input 2202 can be considered to be of two types: (1) navigation input and (2) context update. These terms were defined above.

The output of the context module 2206 is data that describes the current context. In one embodiment, the output encodes the identity of a context 2208. For example, in one medical data input embodiment, four contexts are numbered 0 (“general medical”), 1 (“prescription pad”), 2 (“history of present illness”), and 3 (“enter diagnosis”), and the context output 2208 by the context module 2206 corresponds to the current phase of the medical encounter or task being performed by the physician using the system. In another embodiment, rather than naming the current context, the context module 2206 outputs context-dependent data such words or phrases that are relevant in the current context.

In one multiple-contexts embodiment, multiple contexts are relevant at any given time, and the context output of the context module encodes these multiple contexts. For example, in an embodiment where the context module outputs the identities of the relevant contexts, a list of relevant contexts is output (e.g., “context=general, medical, HPI, chest pain, detail ‘difficulty breathing’”). For example, in an embodiment where the context module outputs per-context data such as words or phrases relevant to the current context, one multiple-contexts embodiment outputs the union of the relevant words and phrases from the relevant contexts.

One example type of multiple contexts embodiment is an embodiment where different sets of contexts represent the situation along generally orthogonal sets of information. For example, in one medical embodiment, the current multiple-context includes three orthogonal factors: the current task, the current patient, and the current user's medical specialty.

Another example type of multiple contexts embodiment is an embodiment where different sets of contexts represent the situation along a hierarchical set of situations, where more specific subsets of context modify more general subsets of context. For example, in one medical embodiment, the current multiple-context includes up to three levels of hierarchical context—application area (e.g., “general medical”, “financial”, “personal”), application task (e.g., “HPI”, “ROS”, “Diagnosis”, “Prescription”, “Order test”, “Narrative”), and application sub-task (e.g., “comment on sore back”, “write prescription for the medication penicillin”, “Comment on MRI”, and “Explain why an MRI is needed”).

In a data entry template embodiment, a data entry template system comprises a number of screens and frames. Each screen or frame provides navigation means and a data input means. The navigation means makes another screen or frame active, causing the system to display the newly active screen or frame. The data input means provides means for entering data into the system. The data inputs means for each frame or screen comprises a digital data input means (e.g., checkbox, radio button, selection list, keyboard text input box) or natural data input means (e.g., microphone for voice input to the active frame, screen for pen input) or both. Data entered via data input means is stored in the system. In one embodiment, the same input can be configured to activate both a navigation means and a data input means (e.g., selecting a radio button also changes a sub-frame on a screen). In this data entry template embodiment, natural input is directed to a particular screen or frame, and this screen or frame corresponds to the context in which the natural input is interpreted. In particular, the context subsystem outputs the context corresponding to the currently active window or frame. In one embodiment, each window or frame's implementation comprises an XML file describing the window or frame. In this embodiment, the XML file for a page or frame also comprises a list of words that are relevant context when the page or frame is active.

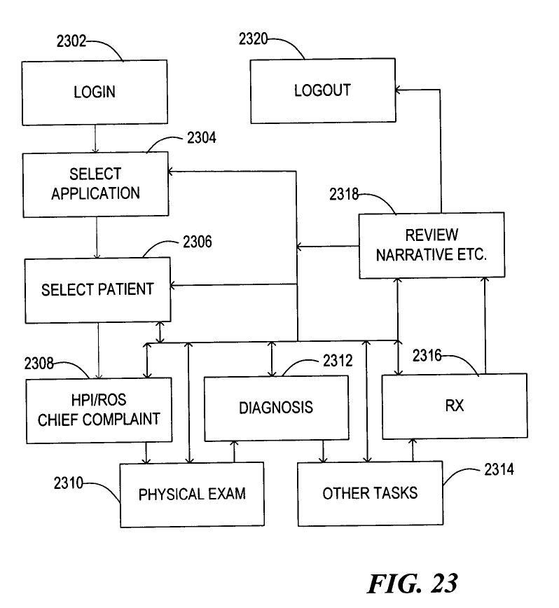

In a medical field data entry template embodiment, the system comprises a number of screens and frames. The screens and frames are arranged into a series of “applications”, “tasks” and “sub-tasks.” An exemplary navigation flow among tasks is illustrated in FIG. 23. In this flow, a user first logs in, as shown in step 2302, then selects an application (e.g., electronic medical record), as shown in step 2304. The user then selects a patient with which to work (e.g., from a list of patients in the clinic.), as shown in step 2306. The user selects a task (e.g., HPI/ROS/Chief complaint 2308, Physical exam 2310, diagnosis 2312, Rx 2316, or other tasks 2314). The user can then switch between tasks. The user can also then navigate to a select patient screen to select a different patient or the select application screen to select a different application (e.g., “check messages”), or finish the current patient and log out. Furthermore, (not displayed in illustration) within each task are several sub-tasks (e.g., within the HPI/ROS/Chief Complaint task are subtasks such as “comment on FINDING” where FINDING represents a data item that has been entered via digital input means and the subtask “comment on FINDING” provides the opportunity for the user to provide free-form natural input regarding the FINDING via handwriting recognition or voice recognition or both. In this embodiment, each task corresponds to a screen and each sub-task corresponds to a frame within a screen.

The context module assembles the relevant context using both a hierarchical context and an orthogonal context means. In particular, the current context corresponds to the union of the contexts from (a) the current application, (b) the current patient (if any), (c) the current task within an application, and (d) the current subtask (if any). In one embodiment, each application, each task, and each sub-task is associated with an XML file that comprises information to be displayed when the application/task/sub-task is active; the XML file also comprises a list of words and phrases that are likely to be entered when the application/task/sub-task is active. Furthermore, when a patient is selected, the system queries a storage system for records regarding that patient. The results of this query comprise a list of active problems, a list of allergies, and a list of current medications. Each element of these lists corresponds to one or more elements in a medical taxonomy or nomenclature such as the Center for Disease Control ICD9 code or the Medicomp Systems Medcin (R) nomenclature. Each element in the nomenclature is associated with zero or more relevant context words or phrases. The system takes the union of relevant context words or phrases from the findings associated with the current user, and the resulting set of words or phrases represent the patient-context. The system then takes the union of the patient-context and the application/task/sub-task contexts and this set represents the current context, which is output by the context module.

In another embodiment, context relevant to the currently selected patient comprises one or more of the patient's name, words and phrases relating to the patient's past family medical and social history, words and phrases relating to the patient's active or past problems, words and phrases relating to medications the patient has taken, words or phrases relating to tests that have been performed on the patient, words or phrases relating to findings or orders entered into the system regarding the patient during the current medical encounter, and words and phrases relating to the patient's demographics (e.g., gender, marital status, age).

In another embodiment of a medical field data entry template system, rather than encode the context as a set of words and phrases, the context output by the system includes (a) the identity of the current application, task, and sub-task (if any) and (b) a set of words and phrases relevant to the current patient. In this embodiment, the recognizer subsystem activates the specialized recognizers or recognizer state associated with the current application, the current task, and the current sub-task, and it also uses the words and phrases relevant to the current patient as input to its recognizer subsystems.

In one medical field embodiment, each time a navigation action switches the active screen or frame, the context output by the context module is updated. Furthermore, in this embodiment, each time a finding or other data is entered about the current patient, the context output by the context module is updated.

In one medical embodiment, specialized context information is stored for different tasks such as HPI, ROS, PMFSH, orders, labs, Rx, enter diagnosis, coding, and narrative. Specialized context information may be stored for different categories of user such as for different roles (e.g., doctor, nurse, consultant, nurse practitioner, orderly, paramedic, military field treatment) and such as for different specialties or clinic types (e.g., cardiologist, general practitioner, pediatrics, emergency room, geriatrics, military field treatment.) Specialized content information may be stored for different elements of information about a patient such as the patient's name, current/past medications, active problems, PMFSH, findings or data elements entered for the current encounter, and findings or data elements entered for past encounters. In one medical embodiment, specialized content information may be stored for different situations or patient populations such as flu season, responding to a mass casualty explosion, responding to an auto accident, responding to a poison gas attack, and so on.

The system described herein has application in a number of fields and systems. For example, in an auto mechanic embodiment, a template system provides data input and navigation means for various tasks on various types of automobile. Each screen or frame in the template system provides relevant context to the recognizer subsystem. Relevant context includes the current task (e.g., changing oil, removing engine) and current subject (auto make, model and year).

In a student note-taking embodiment, the system uses the subject of the class that the student is attending to select a class-specific vocabulary provided by the class's textbook publisher. This vocabulary acts as the relevant context during the class. The context module may also use the subject of the class that the student is attending to select a class-specific vocabulary provided by the class's textbook publisher. This vocabulary acts as the relevant context during the class.

In a business note-taking embodiment, the system uses Bluetooth® to determine who else is in the room. Those names are relevant context. The system may also use documents opened by user or previous notes with same people in room. These may be all context.

The recognition system may be use in various other applications such as delivery situations (e.g., UPS), automobile mechanics, students, medical applications, email dictation (other messages to/from specified individual), shopping (standing in kitchen: using location sensor detect context; context is “in kitchen”, predicting words that are used in kitchen), and retail sales.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of recognizing input, the method comprising:
receiving input data;
receiving context data associated with the input data, the context data associated with an interpretation mapping; and
generating symbolic data from the input data using the interpretation mapping.

2. The method of claim 1, wherein the interpretation mapping is selected from a plurality of interpretation mappings.

3. The method of claim 1, wherein the input data comprises handwriting.

4. The method of claim 1, wherein the input data comprises voice data.

5. The method of claim 1, wherein the context data comprises data entry form element data.

6. The method of claim 1, wherein the context data comprises hierarchical information.

7. An input recognition system comprising:
a context module configured to receive context input and configured to provide context data;
an input capture module configured to receive input data and configured to provide digitized input data; and
a recognition module coupled to the context module and coupled to the input capture module, the recognition module configured to receive the digitized input data, the recognition module configured to interpret the digitized input data utilizing an interpretation mapping associated with the context data.

8. The input recognition system of claim 7, wherein the interpretation mapping is selected from a plurality of interpretation mappings.

9. The input recognition system of claim 7, wherein the input data comprises handwriting.

10. The input recognition system of claim 7, wherein the input data comprises voice data.

11. The input recognition system of claim 7, further comprising:
at least one additional recognition module; and
a router module configured to utilize the context data to selectively send digitized input data to one selected recognition module.

12. The input recognition system of claim 7, further comprising:
at least one additional recognition module; and
a multiplexor configured to utilize the context data to select symbolic output from one selected recognition module.

13. The input recognition system of claim 7, further comprising a feedback module configured to receive symbolic data associated with the interpretation of the digitized input data and configured to receive the digitized input data, the feedback module configured to receive user input and configured to produce feedback data.

14. The input recognition system of claim 7, wherein the context data comprises user data.

15. The input recognition system of claim 7, wherein the context data comprises medical data.

16. The input recognition system of claim 7, wherein the context data comprises template based data.

17. The input recognition system of claim 7, wherein the context data comprises hierarchical data.

18. A medical system comprising:
at least one input capture module configured to capture input data and configured to provide digitized input data;
a context module configured to receive medical workflow data and configured to provide context data;
a plurality of interpretation mappings, the context data associated with at least one interpretation mapping of the plurality of interpretation mappings; and
a recognition module configured to generate symbolic data from the digitized input data utilizing the at least one mapping associated with the context data.

19. The medical system of claim 18, wherein the context data comprises a template location.

20. The medical system of claim 18, wherein the context data comprises patient data.
